(19) United States
(12) Patent Application Publication
(10) Pub. No.: US 2014/0034690 A1
(43) Pub. Date: Feb. 6, 2014

(54) FISH STRINGER SYSTEM

(71) Applicant: David W. Reynolds, Apache Junction, AZ (US)

(72) Inventor: David W. Reynolds, Apache Junction, AZ (US)

(21) Appl. No.: 14/052,741

(22) Filed: Oct. 12, 2013

Related U.S. Application Data
(63) Continuation-in-part of application No. 11/378,745, filed on Mar. 17, 2006, now abandoned.

(51) Int. Cl. A01K 65/00

(52) U.S. Cl. CPC A01K 65/00
USPC 224/103

(57) ABSTRACT

A fish stringer system includes multiple stringers of multiple lengths. Each stringer has an outer diameter with a reduced diameter portion. Each snap assembly includes a slider that includes a gap for receiving the reduced diameter portion of the stringer, wherein the slider has an inside dimension that allows the slider to slide over the outer diameter of the stringer. Each snap assembly includes a swivel coupled to the slider, and a snap coupled to the swivel. The sliders may be different colors, any of which can be glow-in-the-dark, and the snaps may be different sizes. The stringer system provides a way to easily put fish on a stringer regardless of where the fisherman is located.

### BACKGROUND

1. Technical Field

This invention generally relates to fishing gear, and more specifically relates to fish stringers.

2. Background Art

Many different types of fish stringers have been developed over the years. One particular type is disclosed in U.S. Pat. No. 3,893,605 entitled “Fish Stringer” issued on Jul. 8, 1975 to Mew. The stringer shown in the Mew patent includes a cable covered with a flexible plastic or rubber-like covering material. The stringer includes a reduced diameter portion where the covering material is not present, along with a plurality of slide elements that include a swivel-mounted hook to which the fish is to be secured. The stringer in the Mew patent was an advance in the art because it allowed a fish to be secured to a hook that was attached to a slide element, and the slide element could then be easily attached to the stringer without lifting other fish on the stringer out of the water and without having to detach the stringer.

The Mew patent discloses putting a loop in the stringer using a metal clip. The unused slide elements may then be stored on the loop by individually attaching each hook of each slide element onto the loop. While this method for storing slide elements succeeds in placing all of the slide elements on the stringer, it suffers from the drawback of having to remove the slide elements one at a time when they are needed. Thus, when a person catches a fish, the person must return to the stringer location, retrieve a slide element off of the loop, attach the fish to the hook attached to the slide element, then slide the slide element onto the stringer. This sequence of operations is not easy when the fisherman has one hand holding a fish, and therefore must perform most of the operations with a single hand. What is needed is an improved way of storing and using the slide elements. In addition, the stringer in the Mew patent is shown in a single length. Many fishermen have need of stringers of different lengths depending on where they are fishing. For example, when fishing from the bank of a lake or stream, a relatively short stringer works just fine. When fishing from a boat, a longer stringer is needed to get the fish into the water. When fishing from a dock or pier, an even longer stringer may be needed to get from the dock or pier to the water. These varying applications give rise to the need for a single stringer system that includes multiple stringers of different lengths, that includes slide elements that may be used on any length stringer, and that includes a convenience way to transport and use the slide elements. The preferred embodiments described in detail below meet all of these needs.

### BRIEF SUMMARY

A fish stringer system in accordance with the preferred embodiments includes stringers of multiple lengths. Each stringer has an outer diameter with a reduced diameter portion. Multiple snap assemblies may be placed on each stringer. Each snap assembly includes a slider that includes a gap for receiving the reduced diameter portion of the stringer, wherein the slider has an inside dimension that allows the slider to slide over the outer diameter of the stringer. Each snap assembly includes a swivel coupled to the slider, and a snap coupled to the swivel. The sliders may be different colors, any of which can be glow-in-the-dark, and the snaps may be different sizes. The stringer system provides a way to easily put fish on a stringer regardless of where the fisherman is located.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The preferred embodiments of the present invention will hereinafter be described in conjunction with the appended drawings, where like designations denote like elements, and:

FIG. 1 is a perspective view of a stringer of a first length in accordance with the preferred embodiments;

FIG. 2 is a perspective view of a stringer of a second length in accordance with the preferred embodiments;

FIG. 3 is a perspective view of a stringer of a third length in accordance with the preferred embodiments;

FIG. 4 is a side view of a snap assembly in accordance with the preferred embodiments;

FIG. 5 is a side view showing placement of a slider onto the reduced diameter portion of a stringer in accordance with the preferred embodiments;

FIG. 6 is the side view shown in FIG. 5 after the slider is placed onto the reduced diameter portion;

FIG. 7 is the side view shown in FIG. 6 after the slider is slid onto the full-diameter portion of the stringer;

FIG. 8 is a side view of a clip that allows carrying many snap assemblies at the same time;

FIG. 9 is a front view of the clip in FIG. 8 taken along the line 9-9;

FIG. 10 is a side view of a first snap assembly that includes a snap of a first size in accordance with the preferred embodiments;

FIG. 11 is a side view of a second snap assembly that includes a snap of a second size in accordance with the preferred embodiments;

FIG. 12 is a side view of a third snap assembly that includes a snap of a third size in accordance with the preferred embodiments;

FIG. 13 is a side view of a clip showing how the clip carrying many snap assemblies at the same time may be attached to and unattached from a stringer; and

FIG. 14 is a side view of a clip showing how the clip carrying many snap assemblies at the same time may be attached to and unattached from a belt

### DETAILED DESCRIPTION

The fish stringer system of the preferred embodiments includes multiple stringers of different lengths, snap assemblies that have snaps of different sizes, and sliders on the snap assemblies that have different colors, any of which can be glow-in-the-dark. The result is a fish stringer system that can satisfy a large variety of fishing needs.

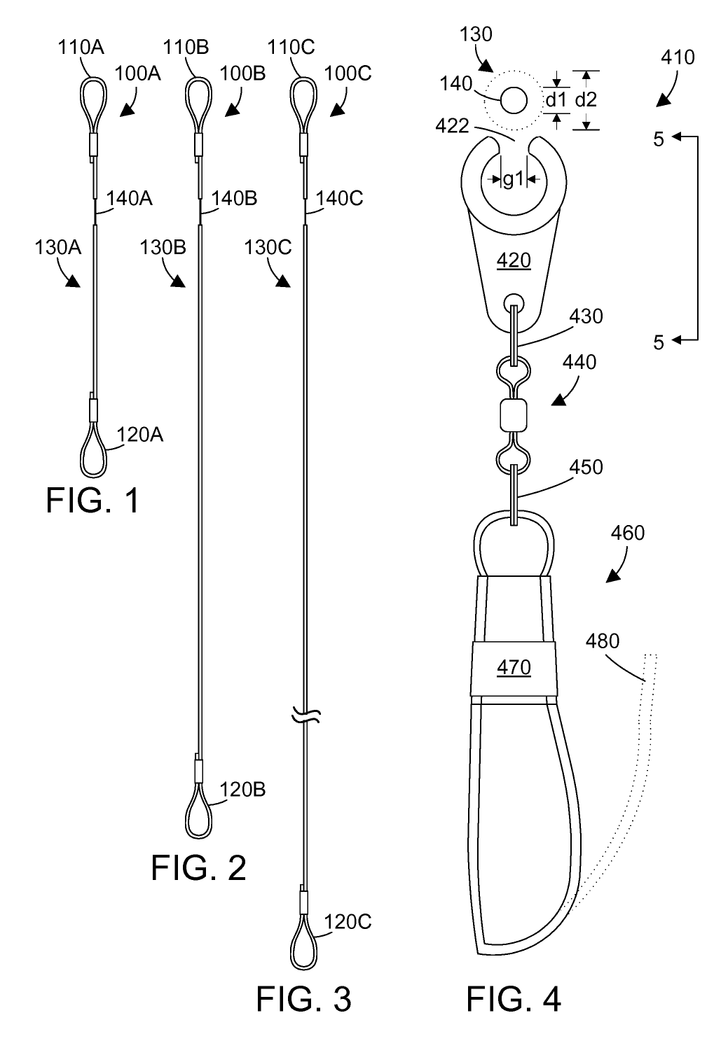

Referring to FIG. 1, a stringer 100A in accordance with the preferred embodiments includes a loop 110A on the first end, a loop 120A on the second end, a full diameter portion 130A, and a reduced diameter portion 140A. The full diameter portion 130A and the reduced diameter portion 140A allow placing snap assemblies onto the stringer 100A without unhooking either end of the stringer, as shown in more detail in FIGS. 4-7.

Similar stringers of two different lengths are also shown in FIGS. 2 and 3. Stringer 100B has two loops 110B and 120B, and a full diameter portion 130B and a reduced diameter portion 140B. Stringer 100C also has two loops 110C and 120C, and a full diameter portion 130C and a reduced diameter portion 140C. The purpose of different length stringers is to accommodate different needs depending upon location. In the most preferred implementation, the shortest stringer is 3 ft. in length; the next stringer is 6 ft. in length; and the longest stringer is 14 ft. in length. These different length stringers allows easily accommodating different fishing locations. For example, the shortest stringer could be used on the bank of a lake or river. The middle-sized stringer could be used on a small boat, such as a canoe, rowboat, or small fishing boat. The longest stringer could be used on a large boat, dock or pier.

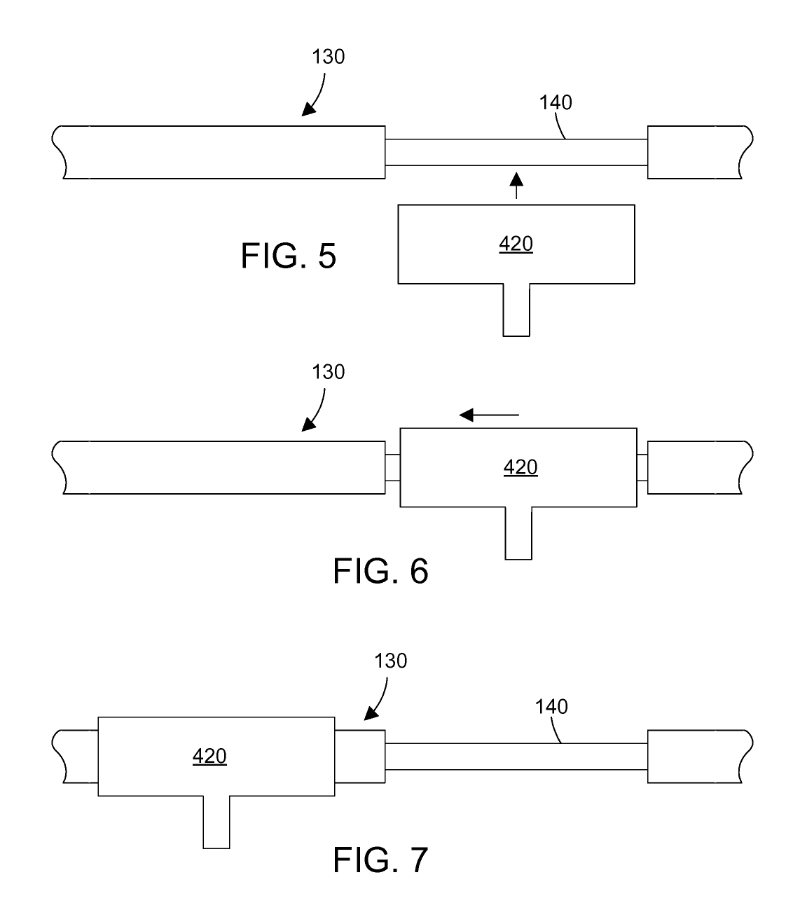

The stringers include full diameter portions 130 and reduced diameter portions 140 so that multiple snap assemblies may be slid onto any of the stringers. A sample configuration of a snap assembly 410 in accordance with the preferred embodiments is shown in FIG. 4. Snap assembly 410 includes a slider 420 coupled to a swivel 440, which is coupled to a snap 460. In the specific implementation shown in FIG. 4, one side of the swivel 440 is attached to the slider 420 via a circular ring 430, and the other side of the swivel 440 is attached to the snap 460 via a circular ring 450. The slider 420 includes an elongated portion (shown better in FIGS. 5-7) with a slot 422 running along the length of the slider 420 that allows the slider to be placed on the reduced diameter portion of a stringer. As shown in FIG. 4, the reduced diameter portion 140 of a stringer has a diameter d1, while the full diameter portion 130 of the stringer has a diameter d2. The slot 422 along the length of the slider has a gap of width g1 that is slightly larger than the diameter d1 of the reduced diameter portion 140 of the stringer so the slider 420 may be placed on the reduced diameter portion 140. The gap width g1 is also substantially smaller than the diameter d2 of the full diameter portion to prevent the slider from coming off the stringer after being slid onto the full diameter portion of the stringer. The internal diameter of the slider is slightly larger than the diameter d2 of the full diameter portion 130 of the stringer so the slider can slide on top of the full diameter portion 130.

The snap 460 opens and closes as is known in the art. The snap 460 is shown in FIG. 4 in its closed position, with the open position indicated in phantom at 480. A fisherman places a fish on the snap by opening the snap to the open position 480, placing the open portion through the gill and mouth of the fish, then closing the snap to a close position. Note that snap 460 also includes a security portion 470 that prevents the snap from coming open accidentally. The security portion 470 preferably slides up and down on the snap. When in the down position shown in FIG. 4, the snap is secure and will not open accidentally. When the fisherman desires to open the snap, the security portion 470 is slid upward, and the snap can then be opened. The security portion 470 prevents a lively fish from squirming around and opening the snap by random thrashing and motion of the fish.

The placement of a slider on a stringer is illustrated in FIGS. 5-7. A slider 420 is shown from the view of line 5-5 in FIG. 4. The gap in the slider 420 is positioned at the reduced diameter portion 140 of the stringer, as shown in FIG. 5. The gap in the slider 420 is then placed on the reduced diameter portion 140, as shown in FIG. 6. The slider 420 is then slid onto the full diameter portion 130, as shown in FIG. 7. Once on the full diameter portion 130, the slider cannot come off the stringer, thereby captivating the snap assembly that includes the slider on the stringer.

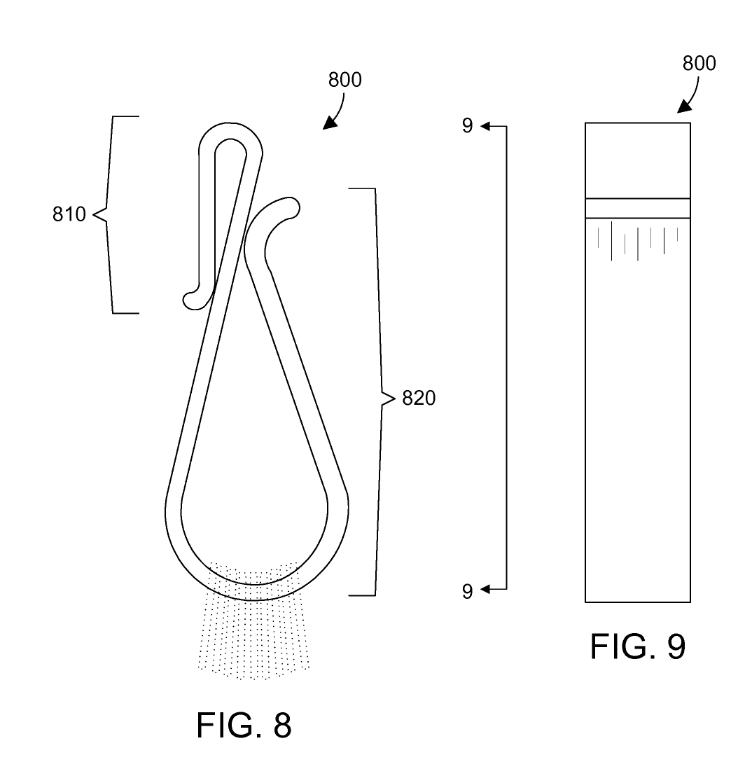

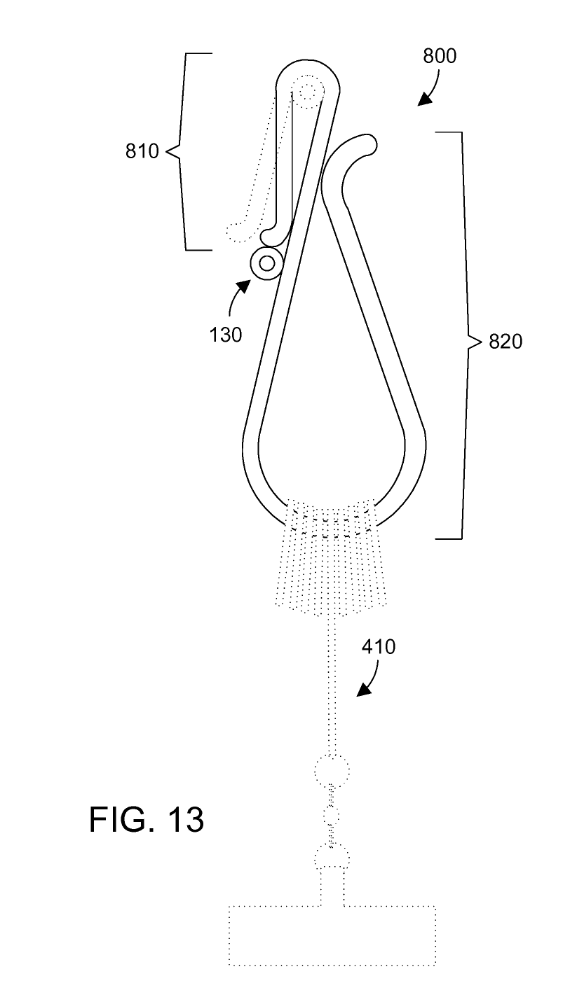

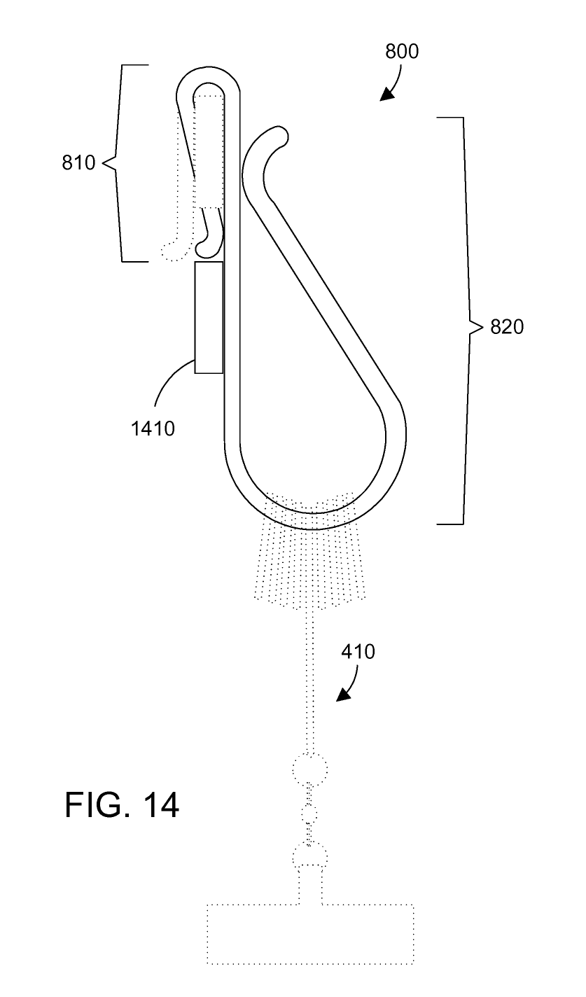

One of the problems with the stringers with removable snaps that are known in the art is the snaps are typically attached to a loop in the stringer one at a time. Thus, when a fisherman catches a fish, he or she must return to the stringer with the fish in hand, undo one of the snaps from the loop, attach the snap to the fish, close the snap, then slide the slider onto the stringer as described above with reference to FIGS. 5-7. This sequence of steps is very difficult to perform one-handed. The preferred embodiments solve this problem by providing a very simple, yet effective way of storing and transporting the snap assemblies. Referring to FIGS. 8, 9, 13 and 14, a plastic clip 800 may be used to carry the snap assemblies in a way that allows many or all of the snap assemblies to be moved in one simple motion. Clip 800 preferably includes an attachment portion 810 and a snap-carrying portion 820. Attachment portion 810 includes a first spring bias that maintains the attachment portion 810 in a normally closed position as shown by the solid lines for the attachment portion 810 in FIGS. 13 and 14. Snap carrying portion 820 preferably includes a second spring bias that maintains the snap-carrying portion 820 in a normally closed position as shown by the solid lines for the snap carrying portion 820 in FIGS. 13 and 14. Snap carrying portion 820 is dimensioned to allow carrying many snap assemblies at one time, which are represented by the snaps in phantom at the bottom of FIG. 8. While only one full snap assembly 410 is shown in FIGS. 13 and 14, the other adjacent portions in phantom in FIGS. 13 and 14 also represent snap portions of snap assemblies, but not all of the snap assemblies are not shown in FIGS. 13 and 14 for clarity. Note the snap portions of snap assemblies 410 are put onto the snap carrying portion of the clip by pressing the snap portion onto the snap carrying portion 820 of the clip 800 with sufficient force to overcome the second spring bias of the snap carrying portion 820, allowing the snap portion to move to the positions on the snap carrying portion shown in FIGS. 13 and 14.

The attachment portion 810 is dimensioned to allow the clip 800 to be easily placed on a stringer, or on a fisherman's belt. Thus, when the snaps and stringers are not in use, the clip 800 with all of the snaps separate from the stringer (i.e., without the sliders attached to the stringer) may be attached to the stringer for storage, as shown in FIG. 13. The stringer in FIG. 13 is shown in cross-section as 130. To place the clip with the snap assemblies onto the stringer, the attachment portion 810 of the clip 800 is positioned to receive the stringer, as shown in the solid lines 130 in FIG. 13. The attachment portion 810 includes a first spring bias that holds the attachment portion in a closed position. The attachment portion 810 is pushed onto the stringer with sufficient force to overcome the first spring bias so the attachment portion opens to receive the stringer, as shown in phantom in the attachment portion 810 of FIG. 13, and the clip is slid onto the stringer until the stringer is in the position at the top of the attachment portion 810, as shown in phantom in FIG. 13, which allows the first spring bias to move the attachment portion 810 to the closed position around the stringer, as shown in FIG. 13. Then when the fisherman is ready to fish, all of the snaps may be easily removed from the stringer in one motion by unattaching the attachment portion 810 of clip 800 from the stringer. This is done by reversing the process of putting the clip onto the stringer, pulling the clip 800 off of the stringer 130 with sufficient force to overcome the first spring bias of the attachment portion 810 until the clip 800 is free from the stringer, as shown by the solid lines in FIG. 13. All of the snaps may then be placed on the fisherman's belt by placing the attachment portion 810 of the clip 800 onto a belt, as shown in FIG. 14. The attachment portion 810 of the clip 800 is pressed onto the belt 1410 with sufficient force to overcome the first spring bias of the attachment portion 810 and is slid until the attachment portion 810 is on the belt 1410, as shown in phantom in FIG. 14. With the snap assemblies on the fisherman's belt, the fisherman has a much more convenient way to place a fish on the stringer. For example, let's assume a fisherman has caught some fish that are already on the stringer, and has wandered 50 yards away from the stringer along the bank of a stream to continue fishing. Using the prior art stringer, if the fisherman catches a fish, he must hold the fish while walking back to the stringer, undo a snap from off the loop in the stringer, attach the fish to the snap, then slide the snap onto the stringer. Using the stringer system of the preferred embodiments, the fisherman places the snap assemblies on his belt using the clip 800. When the fisherman catches a fish, he simply retrieves a snap assembly from the clip on his belt and attaches it to the fish. He still has to walk the 50 yards back to the stringer to place the fish on the stringer, but now the fish is already attached to a snap assembly. The slider may be easily held in a fisherman's fingers much more easily than holding a wet fish that was just caught. Thus, the ability for the fisherman to transport many snaps using the clip 800 provides a significant advantage over the prior art. In addition, once the fisherman is done fishing, he or she may remove the clip 800 from the belt 1410 by lifting the clip 800 off the belt in a single motion, causing the spring bias of the attachment portion 810 to return to the closed position, as shown in the solid lines in FIG. 14, and place the clip back on the stringer as shown in FIG. 13. This allows the stringer, clip and snap assemblies to be stored together, attached to each other, so they are not easily separated and lost.

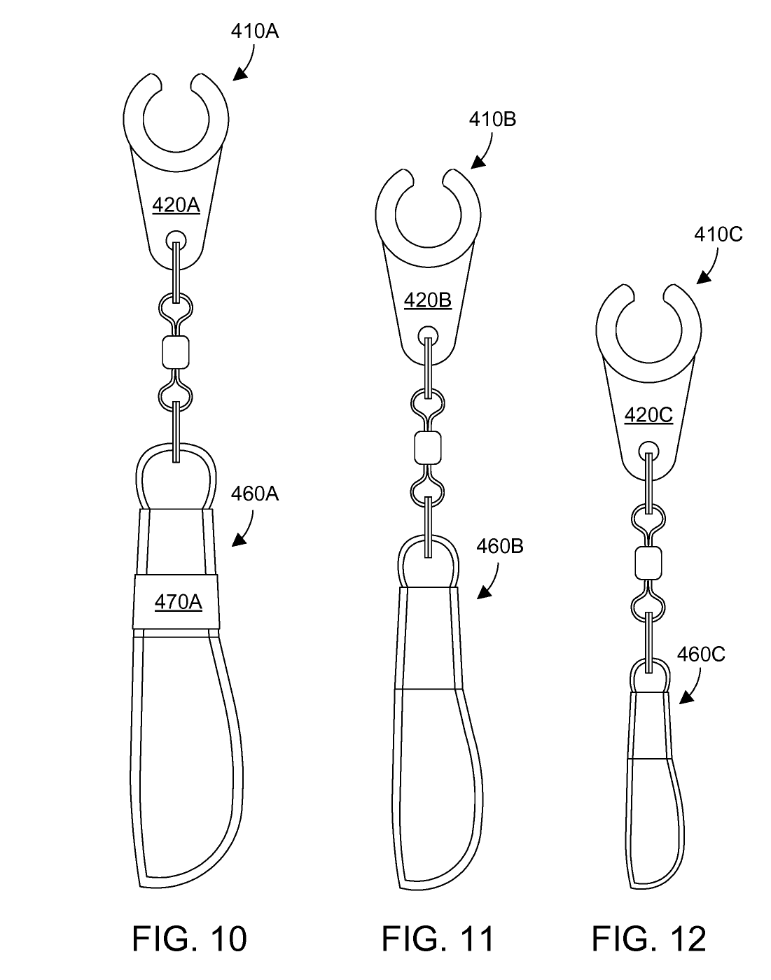

One of the advantages of the stringer system of the preferred embodiments is that the snap assemblies may provide snaps of different sizes. A large snap 460A is shown on the snap assembly 410A in FIG. 10; a medium-sized snap 460B is shown on the snap assembly 410B in FIG. 11; and a small snap 460C is shown on the snap assembly 410C in FIG. 12. The large snap 460A is suitable for many large fish, including catfish and small salt-water fish such as Red Snapper and Trigger Fish. The medium size snap 460B is suitable for most trout and bass. The small snap 460C is suitable for smaller fish such as panfish, crappie, bluegill and perch. A stringer system with snap assemblies that have different sized snaps provides a great advantage for the fisherman because a suitable snap size can be selected to fit the particular fish that is caught. Thus, if a fisherman lands a 9 lb catfish, he could select a snap assembly with a large snap. If the fisherman lands a 2 lb bass, he could select a snap assembly with a medium snap. If the fisherman lands a small bluegill, he could select a snap assembly with a small snap. Providing snap assemblies of different sizes thus provides greater flexibility for the fisherman. Note that the security portion might be omitted for some of the snaps, as shown by the snaps 460B in FIGS. 11 and 460C in FIG. 12 not including the security portion 470A shown in snap assembly 410A in FIG. 10.

One of the significant features of the stringer system of the preferred embodiments is that the sliders 420 on the snap assemblies may be different colors. The reasons for different colors are many. For example, let's assume three buddies are all going fishing together in a small fishing boat. One brings the stringer system of the preferred embodiments with sliders of three different colors. This allows each fisherman to have their own color, which clearly marks their fish from the fish of the other fisherman, even when all are placed on the same stringer. Another use of multiple colors on the sliders is to mark what type of fish is being placed on the stringer, or what size. For example, catfish could be put on a snap assembly that has a black slider, bass could be put on a snap assembly that has a blue slider, and perch could be put on a snap assembly that has a brown slider. In the alternative, three different colors could be used to differentiate between small, medium and large fish. These three examples above all assume the use of three different colors of sliders on the snap assemblies. However, the preferred embodiments expressly extend to snap assemblies that have sliders of a single color, or snap assemblies that have any suitable number of colors. In addition, any of the colors in the snap assemblies may be made of a glow-in-the-dark material that facilitates locating the snap assemblies in the dark.

The stringer system of the preferred embodiments provides significant advantages over the prior art. Multiple stringers of different lengths are provided. The snap assemblies may be placed on any of the stringers. The snap assemblies may include snaps of different sizes, and may include sliders of different colors. In addition, one or more of the snaps may include a security portion that prevents the snap from coming open accidentally. And many or all of the snap assemblies may be stored on the stringer using a clip, and may be all removed from the stringer in one motion by detaching the clip from the stringer. The clip with the snap assemblies may then be placed on a fisherman's belt. When the fisherman is done fishing, the remaining snaps may be easily placed back on the stringer by detaching the clip from the belt and attaching the clip to the stringer for storage.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. A fish stringer system comprising:
a plurality of stringers of different lengths, each stringer having an outer diameter and a reduced diameter portion;
a plurality of snap assemblies, each snap assembly comprising:
a slider having a slot for receiving the reduced diameter portion of the stringer, the slider having an internal dimension greater than the outer diameter of the stringer, thereby allowing the slider to slide past the reduced diameter portion onto the outer diameter of the stringer;
a swivel coupled to the slider;
a snap coupled to the swivel, wherein the snap is configured for attachment to a fish;
wherein the plurality of snap assemblies comprise sliders of a plurality of colors, wherein at least one of the plurality of colors is glow-in-the-dark.

2. The fish stringer system of claim 1 wherein the plurality of snap assemblies comprise snaps of a plurality of sizes.

3. The fish stringer system of claim 1 wherein the snap of at least one of the plurality of snap assemblies comprises a security portion that prevents the snap from becoming unattached from the fish.

4. The fish stringer system of claim 1 further comprising a clip having an attachment portion and a snap-carrying portion, wherein the snap-carrying portion is configured to carry all the snaps of the plurality of snap assemblies.

5. The fish stringer system of claim 4 wherein the attachment portion of the clip is dimensioned to receive one of the plurality of stringers, wherein the plurality of snap assemblies may be attached to the one stringer in a single motion by attaching the attachment portion of the clip to the one stringer when the plurality of snap assemblies are attached to the snap-carrying portion of the clip.

6. The fish stringer system of claim 5 wherein plurality of snap assemblies may be unattached from the one stringer in a single motion by unattaching the attachment portion of the clip from the one stringer when the plurality of snap assemblies are attached to the snap-carrying portion of the clip.

7. The fish stringer system of claim 4 wherein the attachment portion of the clip is dimensioned to receive at least a portion of a belt, wherein the plurality of snap assemblies may be attached to the belt in a single motion by attaching the attachment portion of the clip to the belt when the plurality of snap assemblies are attached to the snap-carrying portion of the clip.

8. The fish stringer system of claim 7 wherein the plurality of snap assemblies may be unattached from the belt in a single motion by unattaching the attachment portion of the clip from the belt when the plurality of snap assemblies are attached to the snap-carrying portion of the clip.

9. A fish stringer system comprising:
a plurality of stringers of different lengths, each stringer having an outer diameter and a reduced diameter portion;
a plurality of snap assemblies, each snap assembly comprising:
a slider having a slot for receiving the reduced diameter portion of the stringer, the slider having an internal dimension greater than the outer diameter of the stringer, thereby allowing the slider to slide past the reduced diameter portion onto the outer diameter of the stringer;
a swivel coupled to the slider;
a snap coupled to the swivel, wherein the snap is configured for attachment to a fish;
wherein the plurality of snap assemblies comprise sliders of a plurality of colors, wherein at least one of the plurality of colors is glow-in-the-dark; and
wherein the plurality of snap assemblies comprise snaps of a plurality of sizes.

10. The fish stringer system of claim 9 further comprising a clip having an attachment portion and a snap-carrying portion, wherein the snap-carrying portion is configured to carry all the snaps of the plurality of snap assemblies.

11. The fish stringer system of claim 10 wherein the attachment portion of the clip is dimensioned to receive one of the plurality of stringers, wherein the plurality of snap assemblies may be attached to the one stringer in a single motion by attaching the attachment portion of the clip to the one stringer when the plurality of snap assemblies are attached to the snap-carrying portion of the clip.

12. The fish stringer system of claim 11 wherein plurality of snap assemblies may be unattached from the one stringer in a single motion by unattaching the attachment portion of the clip from the one stringer when the plurality of snap assemblies are attached to the snap-carrying portion of the clip.

13. The fish stringer system of claim 10 wherein the attachment portion of the clip is dimensioned to receive at least a portion of a belt, wherein the plurality of snap assemblies may be attached to the belt in a single motion by attaching the attachment portion of the clip to the belt when the plurality of snap assemblies are attached to the snap-carrying portion of the clip.

14. The fish stringer system of claim 13 wherein the plurality of snap assemblies may be unattached from the belt in a single motion by unattaching the attachment portion of the clip from the belt when the plurality of snap assemblies are attached to the snap-carrying portion of the clip.

15. The fish stringer system of claim 9 wherein the snap of at least one of the plurality of snap assemblies comprises a security portion that prevents the snap from becoming unattached from the fish.

16. A fish stringer system comprising:
a plurality of stringers of different lengths, each stringer having an outer diameter and a reduced diameter portion;
a plurality of snap assemblies, each snap assembly comprising:
a slider having a slot for receiving the reduced diameter portion of the stringer, the slider having an internal dimension greater than the outer diameter of the stringer, thereby allowing the slider to slide past the reduced diameter portion onto the outer diameter of the stringer;
a swivel coupled to the slider;
a snap coupled to the swivel, wherein the snap is configured for attachment to a fish;
wherein the plurality of snap assemblies comprise sliders of a plurality of colors and snaps of a plurality of sizes, wherein at least one of the plurality of colors is glow-in-the-dark;
wherein the snap of at least one of the plurality of snap assemblies comprises a security portion that prevents the snap from becoming unattached from the fish; and
a clip having an attachment portion and a snap-carrying portion, wherein the snap-carrying portion is configured to carry all the snaps of the plurality of snap assemblies.

17. The fish stringer system of claim 16 wherein the attachment portion of the clip is dimensioned to receive one of the plurality of stringers, wherein the plurality of snap assemblies may be attached to the one stringer in a single motion by attaching the attachment portion of the clip to the one stringer when the plurality of snap assemblies are attached to the snap-carrying portion of the clip.

18. The fish stringer system of claim 17 wherein plurality of snap assemblies may be unattached from the one stringer in a single motion by unattaching the attachment portion of the clip from the one stringer when the plurality of snap assemblies are attached to the snap-carrying portion of the clip.

19. The fish stringer system of claim 16 wherein the attachment portion of the clip is dimensioned to receive at least a portion of a belt, wherein the plurality of snap assemblies may be attached to the belt in a single motion by attaching the attachment portion of the clip to the belt when the plurality of snap assemblies are attached to the snap-carrying portion of the clip.

20. The fish stringer system of claim 19 wherein the plurality of snap assemblies may be unattached from the belt in a single motion by unattaching the attachment portion of the clip from the belt when the plurality of snap assemblies are attached to the snap-carrying portion of the clip.
